(19) United States
(12) Patent Application Publication
(10) Pub. No.: US 2020/0036906 A1
(43) Pub. Date: Jan. 30, 2020

(54) REFRIGERATOR

(71) Applicant: SHARP KABUSHIKI KAISHA, Sakai City (JP)

(72) Inventors: KINYA YAMADE, Sakai City (JP); HIROSHI HISAHARA, Sakai City (JP); YOSHIHIKO HAMAGUCHI, Sakai City (JP); SADAHIKO HINOUE, Sakai City (JP)

(21) Appl. No.: 16/510,169

(22) Filed: Jul. 12, 2019

(30) Foreign Application Priority Data
Jul. 26, 2018 (JP) 2018-140288

(51) Int. Cl. H04N 5/247; H04N 13/243; H04N 7/18; F25D 29/00

(52) U.S. Cl. CPC H04N 5/247; H04N 13/243; F25D 2500/06; F25D 29/005; H04N 7/181

(57) ABSTRACT

A refrigerator includes cameras each disposed on the door of a refrigerating compartment for the corresponding shelf level and arranged in a vertical plane. Each camera has an angle of view that covers the edge of a shelf plate disposed between the corresponding shelf level and a shelf level adjacent to the shelf level.

### BACKGROUND OF THE INVENTION

### 1. Field

The present disclosure relates to a refrigerator.

### 2. Description of the Related Art

Japanese Unexamined Patent Application Publication No. 2002-243335 (laid open on Aug. 28, 2002) discloses a refrigerator described below. The refrigerator includes a camera installed in the refrigerator's door to enable image capture of items stored in the refrigerating compartment. The captured image is transmitted to a portable terminal to provide support in performing tasks based on the image information, such as managing the storage of stored items or purchasing of items.

One issue with the above-mentioned related art is that, when a stored item is placed near the edge of a shelf plate, which is the most frontward area in the refrigerating compartment, the item obstructs almost the entire coverage range of the camera, making it difficult to recognize what the food item is from an image of the item captured by the camera.

An aspect of the present disclosure provides a refrigerator that enables a stored item in the refrigerating compartment to be reliably identified by use of a camera.

### SUMMARY

A refrigerator according to an aspect of the disclosure includes a refrigerating compartment having a plurality of shelf levels each separated by a shelf plate, a door for the refrigerating compartment, and a camera disposed on the door such that the camera faces each shelf level. The camera includes a plurality of cameras each provided for corresponding one of the shelf levels and arranged in a vertical plane parallel to the door. Each camera has an angle of view that covers a door-side edge of a shelf plate disposed between a shelf level that the camera faces and an adjacent shelf level, the adjacent shelf level being positioned in an upwardly or downwardly adjacent-relation to the shelf level.

### BRIEF DESCRIPTION OF THE DRAWINGS

FIG. 1 is a front view of a refrigerator according to Embodiment 1 with a door open;

FIG. 2 is a front view of the inside of a right-hand door of the refrigerator according to Embodiment 1;

FIG. 3A is a front view of the refrigerator according to Embodiment 1 with a door closed;

FIG. 3B is a sectional view taken along a line IIIB-IIIB in FIG. 3A;

FIG. 4 is a side sectional view of a refrigerating compartment included in the refrigerator according to Embodiment 1;

FIGS. 5A to 5C each illustrate an exemplary image captured by a camera of the refrigerator according to Embodiment 1;

FIGS. 6A to 6C each illustrate an image captured by a camera of the refrigerator according to Embodiment 1;

FIG. 7 illustrates an image displayed on the refrigerator according to Embodiment 1;

FIG. 8 is a block diagram illustrating the major components of a refrigerator according to Embodiment 2;

FIG. 9 is a flowchart of a process performed in the refrigerator according to Embodiment 2;

FIG. 10 is a flowchart of a process performed in a refrigerator according to Embodiment 3;

FIG. 11A is a top view of an exemplary shelf plate of a refrigerator according to Embodiment 4; and

FIGS. 11B and 11C are a top view and a sectional view, respectively, of another exemplary shelf plate of the refrigerator according to Embodiment 4.

### DESCRIPTION OF THE EMBODIMENTS

### Embodiment 1

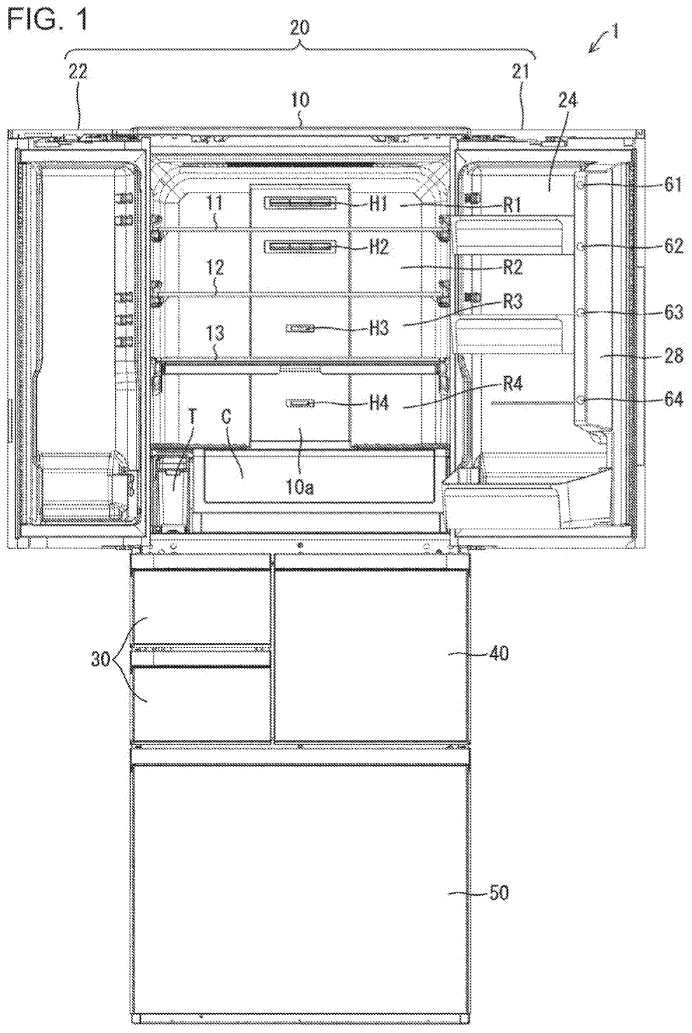

An embodiment of the present disclosure will be described below with reference to FIGS. 1 to 4.

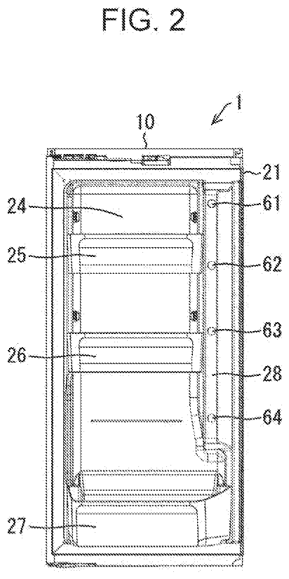

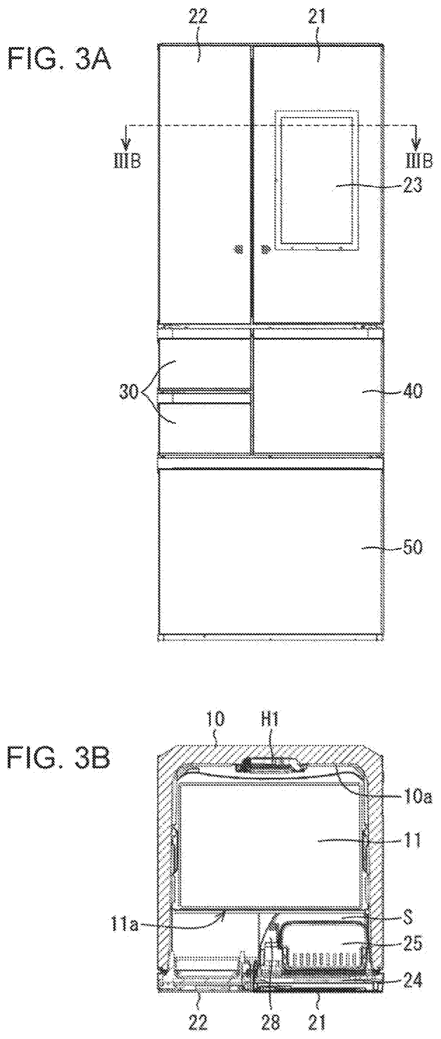

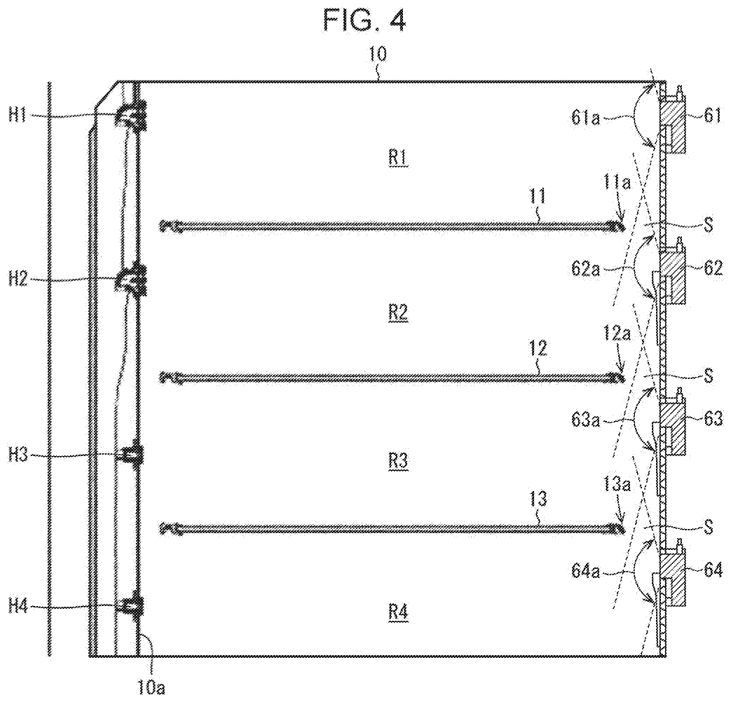

FIG. 1 is a front view of a refrigerator 1 according to Embodiment 1 with a door 20 open. FIG. 2 is a front view of the inside of a right-hand door 21 of the refrigerator 1. FIG. 3A is a front view of the refrigerator 1 with the door 20 closed, and FIG. 3B is a sectional view taken along a line IIIB-IIIB in FIG. 3A. FIG. 4 is a side sectional view of a refrigerating compartment 10 (storage compartment) included in the refrigerator 1.

As illustrated in FIGS. 1 to 4, the refrigerator 1 includes the refrigerating compartment 10, the door 20, an ice-making compartment 30, a vegetable compartment 40, and a freezing compartment 50. FIG. 1 depicts the ice-making compartment 30, the vegetable compartment 40, and the freezing compartment 50 with their doors closed. As long as the refrigerator according to Embodiment 1 includes at least the refrigerating compartment 10, the refrigerator may not include the ice-making compartment 30, the vegetable compartment 40, and the freezing compartment 50.

The refrigerating compartment 10 is in the form of an insulated housing filled with an insulator. Shelf plates 11 to 13 on which to place stored items are disposed inside the refrigerating compartment 10. The shelf plates 11 to 13 are made of an optically transparent material such as glass or resin that allows stored items to be seen from one side to the other through each of the shelf plates 11 to 13. A semi-transparent frame is provided near each of respective edges 11a to 13a of the shelf plates 11 to 13 for the purpose of slip resistance and for the purpose of enabling the location of the edges 11a to 13a to be easily recognized from the corresponding captured images. The edges 11a to 13a herein each refer to the edge at the front, that is, the edge beside the door 20. For brevity, such an edge will be hereinafter referred to simply as edge, rather than edge beside the door.

The refrigerating compartment 10 is separated by the shelf plates 11 to 13 into a plurality of shelf levels. The shelf plates 11 to 13 are, from the top, an upper shelf plate, a middle shelf plate, and a lower shelf plate respectively. The shelf levels include, from the top, an upper shelf level R1, a middle shelf level R2, a lower shelf level R3, and a bottom shelf level R4. Accordingly, an item to be stored into the upper shelf level R1 is placed on the upper shelf plate 11. The same applies to the other shelf levels.

A back wall 10a of the refrigerating compartment 10 has air outlets H1, H2, H3, and H4 provided in this order from the top to blow cold air into the refrigerating compartment 10. Specifically, the air outlets H1 to H4 respectively blow cold air to the interior of the shelf levels R1 to R4. Although a chilling compartment C and a water storage tank T are disposed below the bottom shelf level R4, the chilling compartment C and the water storage tank T may not be provided. An air inlet (not illustrated) is provided below the chilling compartment C to suck in circulating cold air.

The door 20 is provided on the front of the refrigerating compartment 10 in a manner that allows the door 20 to open and close. Specifically, the door 20 includes the right-hand door 21, and a left-hand door 22. The right-hand door 21 and the left-hand door 22 respectively rotate about rotating shafts provided at the right and left edges of the refrigerating compartment 10 to allow opening and closing of the refrigerating compartment 10. However, the refrigerator 1 may not be of such a French door type. Alternatively, the door 20 may be a single door that rotates about a rotating shaft provided at the right or left edge of the refrigerating compartment 10 to allow opening and closing of the refrigerating compartment 10.

The inside of the right-hand door 21 is provided with a plurality of cameras for image capture of the refrigerating compartment 10. Each camera is disposed facing the corresponding one of the shelf levels R1 to R4. An upper camera 61, a middle camera 62, a lower camera 63, and a bottom camera 64 are respectively used mostly to capture images of the upper shelf level R1, the middle shelf level R2, the lower shelf level R3, and the bottom shelf level R4. More specifically, the cameras 61 to 64 respectively corresponding to the shelf levels R1 to R4 are each located at a height that falls within the height range of the corresponding shelf level. The center of the coverage area of each of the cameras 61 to 64 is directed toward the corresponding one of the shelf levels R1 to R4. Each of the cameras 61 to 64 is located near the middle of the refrigerating compartment 10 with respect to the horizontal direction.

Storage pockets 25, 26, and 27 are further provided on the inside of the right-hand door 21. To allow images of the shelf levels R1 to R4 to be captured even when stored items are placed in the storage pockets 25, 26, and 27, the cameras 61 to 64 are disposed on a raised member 28, which protrudes toward the interior of the refrigerating compartment 10 from a door panel 24 of the right-hand door 21, such that the cameras 61 to 64 are aligned in the vertical direction. This ensures that, in Embodiment 1, the storage pockets 25 to 27 do not appear in the images captured by the cameras 61 to 64. Alternatively, however, the storage pockets 25 to 27 may be allowed to appear at an edge portion of the coverage range of the cameras 61 to 64 to such an extent that does not hinder image capture of stored items in the shelf levels R1 to R4 by the cameras 61 to 64. As the cameras 61 to 64, for example, various known imaging apparatuses may be used, such as charge coupled device (CCD) cameras or complementary metal oxide semiconductor (CMOS) cameras.

As illustrated in FIG. 3A, the outer surface of the right-hand door 21 is provided with a display 23. The display 23 may be, for example, a liquid crystal display. The display 23 is capable of presenting the user with information related to operation of the refrigerator, an image captured by a camera, or other information. Further, as partially illustrated in FIG. 3B, a space S exits between the following components: the shelf plates 11 to 13 (the upper shelf plate 11 is depicted in FIG. 3B); the storage pockets 25 to 27 (the storage pocket 25 is depicted in FIG. 3B); and the cameras 61 to 64 (the raised member 28 is depicted in FIG. 3B).

The longitudinal sectional view of FIG. 4 depicts respective angles of view 61a to 64a of the cameras 61 to 64 at the same time. For example, the angle of view 61a of the upper camera 61 covers the edge 11a of the upper shelf plate 11, which is a shelf plate located between the upper shelf level R1 and the middle shelf level R2. That is, at least the edge 11a of the upper shelf plate 11 appears in an image captured by the upper camera 61, and even the space S beyond the edge 11a is included in the image. Likewise, at least the edge 11a of the upper shelf plate 11 and the edge 12a of the middle shelf plate 12 appear in an image captured by the middle camera 62, and even the space S beyond each of the edges 11a and 12a is included in the image. The same applies to images captured by other cameras. Accordingly, the cameras 61 to 64 respectively have very wide angles of view 61a to 64a, which can be, for example, about 130 degrees or more and are typically about 150 degrees. Any camera having an angle of view that satisfies the above-mentioned condition may be selected as such a camera in accordance with the positional relationship between the camera and the corresponding shelve. As used herein, the term angle of view refers to the angle of view in at least the vertical (top-bottom) direction.

As for the method for manufacturing the refrigerator 1 according to Embodiment 1, such a method can be easily conceived of by a person skilled in the art by suitably employing a known refrigerator manufacturing technique in accordance with the above-mentioned configuration.

Characteristic operation of the refrigerator 1 according to Embodiment 1 will be described next. The following description will be directed to an image captured of the middle shelf level R2 where a stored item B is placed.

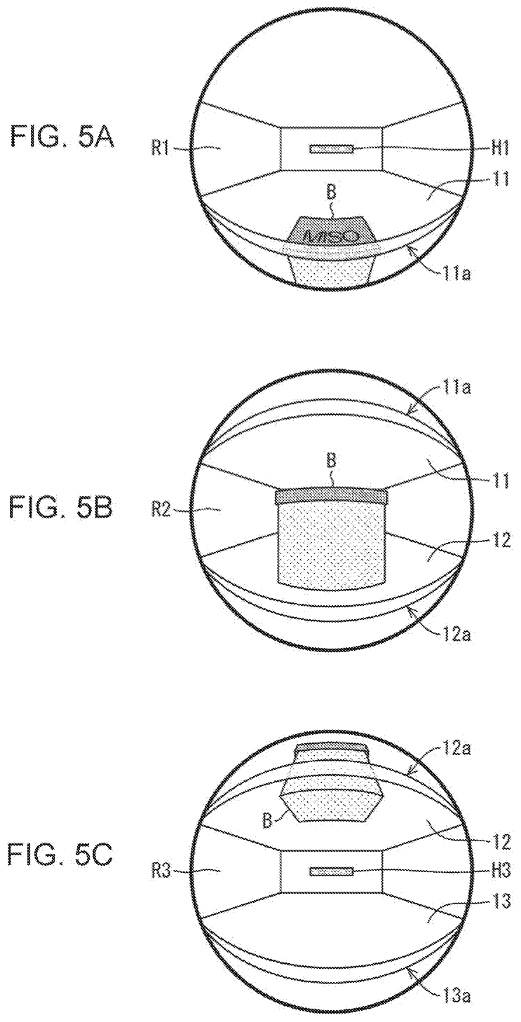

FIGS. 5A to 5C respectively illustrate images captured by the cameras 61 to 63 when the stored item B in the middle shelf level R2 is placed at a position near but slightly inward of the edge 12a of the middle shelf plate 12 such that the stored item B does not stick out over the edge 12a. Since the cameras 61 to 63 each have a very wide angle of view as described above, the image captured by such a camera is distorted. In Embodiment 1, an image captured by a camera with a fisheye lens will be described as such a captured image.

FIG. 5B illustrates an image captured by the middle camera 62, which is used mostly to capture an image of the middle shelf level R2. The upper shelf plate 11 and the middle shelf plate 12, as well as their respective edges 11a and 12a are visible in upper and lower parts of the image. The entire front-side surface of the stored item B is visible in the image captured by the middle camera 62. However, since only the front-side surface with no distinctive characteristics is visible to the user, it is somewhat difficult for the user to determine what the stored item B is.

FIG. 5A illustrates an image captured by the upper camera 61. The edge 11a of the upper shelf plate 11 is visible in a lower part of the captured image. The topside surface and front-side surface of the stored item B can be seen directly or through the upper shelf plate 11 made of a transparent material. The user is thus able to recognize the three-dimensional form of the stored item B, allowing the user to determine that the stored item B is a Miso (fermented soybean paste) pack. Further, the product label provided only on the topside of the stored item B is visible, and this also helps the user determine what the stored item B is.

FIG. 5C illustrates an image captured by the lower camera 63. The edge 12a of the middle shelf plate 12 is visible in an upper part of the captured image. The underside surface and front-side surface of the stored item B can be seen directly or through the middle shelf plate 12 made of a transparent material. The user is thus able to recognize the three-dimensional form of the stored item B, allowing the user to determine that the stored item B is a Miso pack.

As described above, since the stored item B is placed at the front, only the front-side surface of the stored item B is visible in the image captured by the middle camera 62, making it difficult for the user to recognize the three-dimensional form of the item. For this reason, depending on the configuration, pattern, or other features of the stored item, the user may, in some cases, be unable to recognize what the item is in some cases. However, from images captured by other cameras such as the upper camera 61 and the lower camera 63, in addition to the front-side surface of the stored image, surfaces other than the front-side surface are also visible to the user. This allows the user to recognize the three-dimensional form of the stored item, and thus easily recognize what the stored item is. In the example illustrated in FIGS. 5A to 5C, through comprehensive assessment of the images captured by the cameras 61 to 63, the user is able to easily recognize what the stored item is.

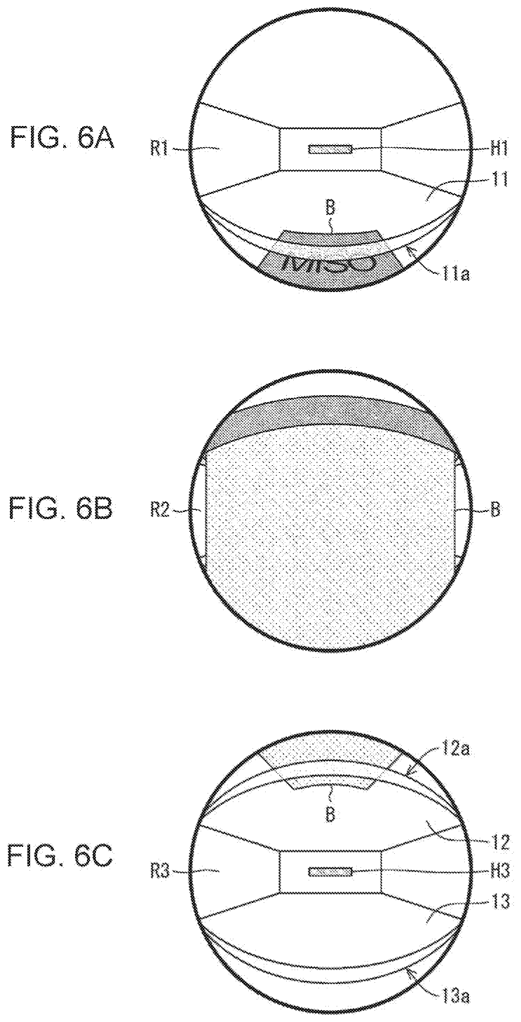

FIGS. 6A to 6C respectively illustrate images captured by the cameras 61 to 63 when the stored item B in the middle shelf level R2 is placed such that the item partially sticks out over the edge 12a of the middle shelf plate 12. As illustrated in FIG. 6B, since the stored item B is placed immediately near the middle camera 62, the stored item B occupies and obstructs the coverage area of the middle camera 62. This means that from the image captured by the middle camera 62, the user is virtually unable to determine what the stored item B is. However, in the image captured by the upper camera 61 illustrated in FIG. 6A, the topside surface of the stored item B is shown as lying over the edge 11a of the upper shelf plate 11, and from the label on the topside, the user is able to recognize that the stored item B is a Miso pack. In the image captured by the lower camera 63 illustrated in FIG. 6C, the underside of the stored item B is visible. As described above, in the case where the stored item B is stored as illustrated in FIGS. 6A to 6C, the user is unable to recognize what the stored item B is from the image captured by the middle camera 62 alone. However, through comprehensive assessment of the images captured by the cameras 61 to 63, the user is able, to some extent, to recognize the three-dimensional form of the stored item in the middle shelf level R2. This makes it possible for the user to identify the stored item B. In the present case, the user is also able to see the label on the topside from the image captured by the upper camera 61, thus allowing the user to recognize what the stored item is.

As described above, in some cases, it is difficult or not possible for the user to recognize what a stored item placed in the middle shelf level R2 is from the image captured by the middle camera 62 alone, particularly when the stored item is placed near the edge of the shelf plate. However, the refrigerator 1 according to Embodiment 1 presents the user also with images captured by other cameras such as the upper camera 61 and the lower camera 63, thus enabling the user to more reliably recognize what the stored item is. The images to be presented to the user can be displayed on the display 23 of the refrigerator 1. Alternatively, such images may be displayed via communication on a portable terminal located outside the refrigerator 1.

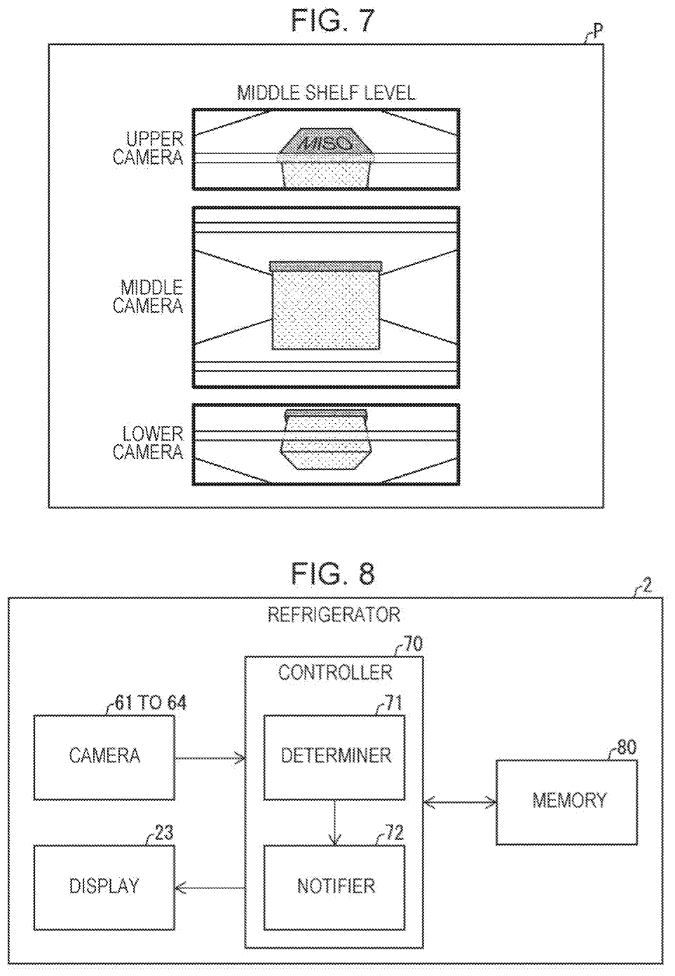

The following describes further exemplary adaptations of the method for presenting these captured images. The images captured by the cameras 61 to 63 illustrated in FIGS. 5A to 5C and FIGS. 6A to 6C each provide a wide angle of view and thus cover a plurality of shelf levels. Accordingly, for easy recognition by the user, in one exemplary configuration, areas particularly related to the shelf levels R1 to R4 are cropped out for presentation to the user. In another exemplary configuration, since the images captured by the cameras 61 to 63 are distorted, these images are corrected for distortion before being presented to the user. FIG. 7 illustrates a presentation image P presented to the user, which is obtained by applying the above-mentioned processing to the images captured by the cameras 61 to 63 illustrated in FIGS. 5A to 5C. Showing the presentation image P as an image representing the state of the middle shelf level R2 makes it easier for the user to recognize what the stored item B is.

In one exemplary configuration, the presentation image P illustrated in FIG. 7 is presented in response to a user's operation. Specifically, unless the user performs a special operation, the user is presented with a presentation linage including an arrangement of images obtained by cropping and correcting front-view images of the shelf levels R1 to R4 respectively captured by the cameras 61 to 64 facing the shelf levels R1 to R4. If, for example, the user performs an operation for specifically selecting the middle shelf level R2 and viewing images of areas above and below the middle shelf level R2, then the image illustrated in FIG. 7 is presented to the user. Accordingly, under normal conditions, the user is able to check all of the images of the shelf levels R1 to R4, and as occasion demands, the user is able to closely examine the state of a specific shelf level.

Although the foregoing description is directed to the case where the stored item B is stored in the middle shelf level R2, it goes without saying that the same as described above also applies to the other shelf levels R1, R3, and R4.

The refrigerator according to Embodiment 1 includes the cameras 61 to 64 respectively facing the shelf levels R1 to R4 that are vertically adjacent to each other. The cameras 61 to 64 are disposed in the same vertical straight line. The vertically adjacent cameras 61 to 64 thus complement each other to enable acquisition of images used to check items stored in the shelf levels R1 to R4. This also helps ensure that the raised member 28 of the right-hand door 21 where the cameras are attached extends in a vertical line. This helps provide maximum area for the storage pockets 25 to 27 on the right-hand door 21 which serve as storage spaces. However, the cameras 61 to 64 may not be arranged in the same vertical line but may be arranged in any manner as long as the cameras 61 to 64 lie in the same vertical plane parallel to the right-hand door 21 (door panel 24). In this case as well, the vertically adjacent cameras 61 to 64 complement each other to enable acquisition of images used to check items stored in the shelf levels R1 to R4. In another exemplary configuration, the cameras 61 to 64 may be arranged in oblique or staggered relation to each other in the same vertical plane. Although the foregoing description is directed to an exemplary case in which each of the respective angles of view 61a to 64a of the cameras 61 to 64 each covers the edges of the corresponding shelf level in both upper and lower parts, this may not be the case. For example, the angle of view may cover the edges of the corresponding shelf level only in its upper or lower part. In this case, each of the cameras 61 to 64 may be able to complement only the camera located above or below.

Each camera may have an angle of view that covers the door-side edge of at least one shelf plate located above or below the shelf level that the camera faces, which is a shelf plate that separates off a shelf level positioned in at least one of upwardly and downwardly adjacent relations to the above-mentioned shelf level. For example, at least the edge 12a of the middle shelf plate 12 and the edge 13a of the lower shelf plate 13 appear in an image captured by the middle camera 62. Consequently, the front-side surface of an item stored at the front edge of the lower shelf level R3 can be viewed by means of not only the lower camera 63 facing the lower shelf level R3 but also the middle camera 62 facing the middle shelf level R2 positioned in an upwardly adjacent relation to the lower shelf level R3, thus allowing the user to easily recognize the stored item.

### Embodiment 2

Another embodiment of the present disclosure will be described below. For the convenience of explanation, components similar in function to the components described above with reference to Embodiment 1 will be designated by the same reference symbols, and their description will not be repeated. The same applies to other embodiments described below.

A refrigerator 2 according to Embodiment 2 is similar in structure to the refrigerator 1 illustrated in FIGS. 1 to 4, and further includes a controller 70 and a memory 80. FIG. 8 is a block diagram illustrating the major components of the refrigerator 2. The cameras 61 to 64 and the display 23 are configured in the same manner as described above. The controller 70 includes a determiner 71, and a notifier 72. The determiner 71 determines, based on an image captured by each of the cameras 61 to 64, the state in which a stored item is placed in each of the shelf levels R1 to R4. The notifier 72 notifies the user in accordance with the determination made by the determiner 71. The notifier 72 may, for example, alert the user by displaying an alert image on the display 23. If the refrigerator 2 is equipped with a speaker, the notifier 72 may alert the user by outputting an alert sound from the speaker. The memory 80 stores data used by the controller 70 in controlling the refrigerator 1. The memory 80 may record images captured by the cameras 61 to 64. The controller 70 may, upon request from the user, display a captured image recorded in the memory 80 on the display 23. Further, the notifier 72 may transmit an image via a communication line.

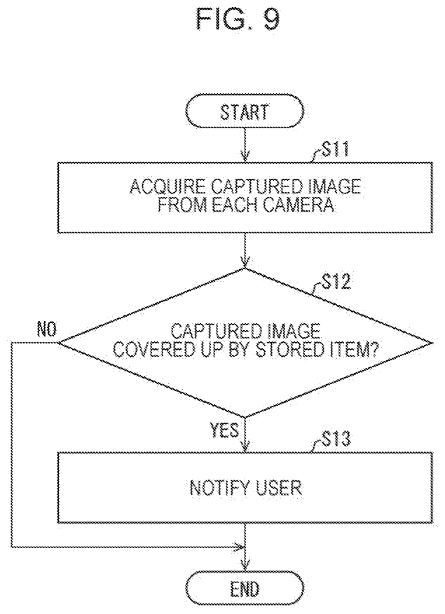

A process related to each of the shelf levels R1 to R4 in the refrigerator 2 according to Embodiment 2 will be described below with reference to the flowchart of FIG. 9.

First, the determiner 71 acquires a captured, image from each of the cameras 61 to 64 (S11). The determiner 71 then determines whether the acquired captured image is covered up by a stored item (S12). One specific exemplary criterion in this case may be to determine whether a region greater than or equal to about 40% of the area of the captured image and including the central part of the captured image is occupied by a single stored item. However, such a criterion is illustrative only and any criterion may be set as appropriate. Alternatively, a plurality of conditions serving as such criteria (such as area, location, brightness, and other conditions that make it possible to determine the size, location, state, or other features of a stored item) may be provided in advance for selection by the user.

It is determined that the captured image is covered up by a stored item (as in the case of the image illustrated in FIG. 6B) (YES at S12), it is determined that the stored item is in close proximity to the camera an a stored in an inappropriate state. In this case, the notifier 72 notifies the user to that effect (S13), and the process is ended. If the acquired captured image is not covered up by a stored item (as in the case of the image illustrated in FIG. 5B) (NO at S12), the process is ended (S13 is skipped). The determiner 71 performs the above-mentioned process for each of the cameras 61 to 64.

In one exemplary configuration, the above process may be started upon closing of the door 20, and if a stored item is stored in an inappropriate state, the user may be notified to that effect and urged to improve the storage state.

Convenience provided to the user through the above-mentioned operation will be described below.

First, the user is notified if an item is stored in an inappropriate state, thus allowing the user to improve the storage state. This helps reduce the occurrence of situations where it is difficult to identify an item stored in each of the shelf levels R1 to R4. In particular, by notifying the user immediately after the door 20 is closed, the user is allowed to quickly improve the storage state. This helps reduce the occurrence of situations where, for example, the user has a captured image displayed on a portable terminal in order to check an item stored in the refrigerating compartment 10 while away from home, but the user is unable to check the storage state of the item in a satisfactory manner because the item is stored inappropriately.

Second, if the user improves the storage state, imbalances in cooling between various areas in the refrigerating compartment 10 can be reduced. This is explained below with reference to FIG. 3B and FIG. 4. Cold air introduced into the refrigerating compartment 10 from the air outlets H1 to H4 flows toward the door 20 via the corresponding shelf levels R1 to R4. Subsequently, the cold air is recovered through the air inlet below the chilling compartment after passing through the space S located between the door and the respective edges 11a to 13a of the shelf plates 11 to 13, and then circulates again. Accordingly, if stored items are placed all the way to a position immediately near the cameras 61 to 64 such that the items stick out into the space S, circulation of cold air is hindered. Insufficient circulation of cold air can cause excessive cooling to occur only in the vicinity of a specific air outlet, which can cause stored items to freeze. Conversely, such placement of items may create localized areas of insufficient cooling. Potential occurrence of such cooling imbalances can be reduced by notifying the user to that effect.

The first and second features mentioned above are independent from each other. That is, if at least one of these effects is exerted, then the characteristic effect of the refrigerator 2 according to Embodiment 2 is exerted.

### Embodiment 3

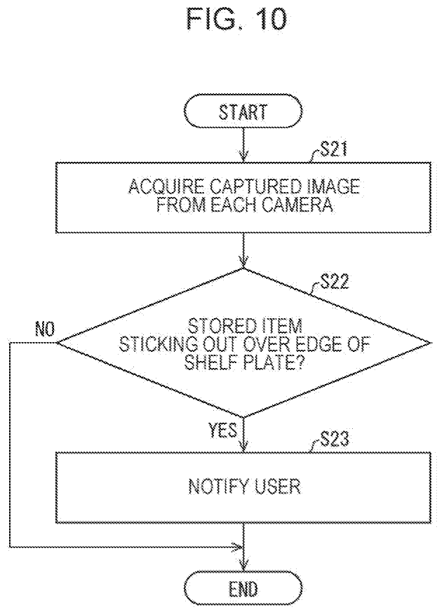

A refrigerator according to Embodiment 3 are similar in configuration to the refrigerator 2 illustrated in FIGS. 1 to 4 and FIG. 8. In the case of the refrigerator according to Embodiment 3 as well, the determiner 71 determines, based on an image captured from each of the cameras 61 to 64, the state in which a stored item is placed in each of the shelf levels R1 to R4. However, the refrigerator according to Embodiment 3 differs from the refrigerator 2 according to Embodiment 2 in the process achieved by the controller 70. A process related to each of the shelf levels R1 to R4 in the refrigerator according to Embodiment 3 will be described below with reference to the flowchart of FIG. 10. Although the following description is directed to a process performed for the middle shelf level R2 by way of example, the same applies to the other shelf levels R1, R3, and R4.

First, the determiner 71 acquires a captured image from each of the upper camera 61 and the lower camera 63, which are cameras respectively disposed facing the shelf levels R1 and R3 adjacent to the middle shelf level R2 (S21). Subsequently, the determiner 71 examines a lower part of the image captured by the upper camera 61, and an upper part of the image captured by the lower camera 63 to thereby determine whether a stored item placed in the middle shelf level R2 stick out over the edge 12a of the middle shelf plate 12 (S22). If it is determined that the stored item stick out over the edge 12a of the middle shelf plate 12 (as in the case of the images illustrated in FIGS. 6A and 6C) (YES at S22), it is determined that the stored item is stored in an inappropriate state. In this case;, the notifier 72 notifies the user to that effect (S23), and the process is ended. If it is determined that the stored item does not stick out over the edge 12a of the middle shelf plate 12 (as in the case of the images illustrated in FIGS. 5A and 5C) (NO at S22), the process is ended (S23 is skipped). The refrigerator according to Embodiment 3 performs the above-mentioned process for each of the cameras 61 to 64.

In one exemplary configuration, the above process may be started upon closing of the door 20, and if a stored item is stored in an inappropriate state, the user may be notified to that effect and urged to improve the storage state.

Convenience provided to the user through the above-mentioned operation will be described below.

First, the user is notified if an item is stored in an inappropriate state, thus allowing the user to improve the storage state. This helps reduce the occurrence of situations where it is difficult to identify an item stored in each of the shelf levels R1 to R4.

Second, imbalances in cooling between various areas in the refrigerating compartment 10 can be reduced. The reason for this is as the same as described above with reference to Embodiment 2.

In the foregoing description, in determining whether a stored item sticks out over a shelf plate at S22, each of the edges 11a to 13a is used as the boundary region beyond which the stored item is not to be placed. However, this may not be the case. The boundary region may be located either inside or outside each of the edges 11a to 13a. To this end, any suitable region near each of the edges 11a to 13a may be set as a region where a stored item is not to be placed.

### Embodiment 4

One characteristic feature of each of the refrigerators according to the above-mentioned embodiments resides in that, with regard to the middle shelf level R2 by way of example, the state of placement of a stored item in the middle shelf level R2, in particular, the state of placement of a stored item near the edge 12a is checked by using not only an image captured by the middle camera 62 but also images captured by other cameras such as the upper camera 61 and the lower camera 63. A refrigerator according to Embodiment 4 has a pattern provided in an area near each of the respective edges 11a to 13a of the shelf plates 11 to 13. This allows each of the edges 11a to 13a of the shelf plates 11 to 13 to be readily recognized within the captured images acquired from the cameras 61 to 64 located above or below, thus making it easier for the user to determine the state in which an item is stored near each of the edges 11a to 13a.

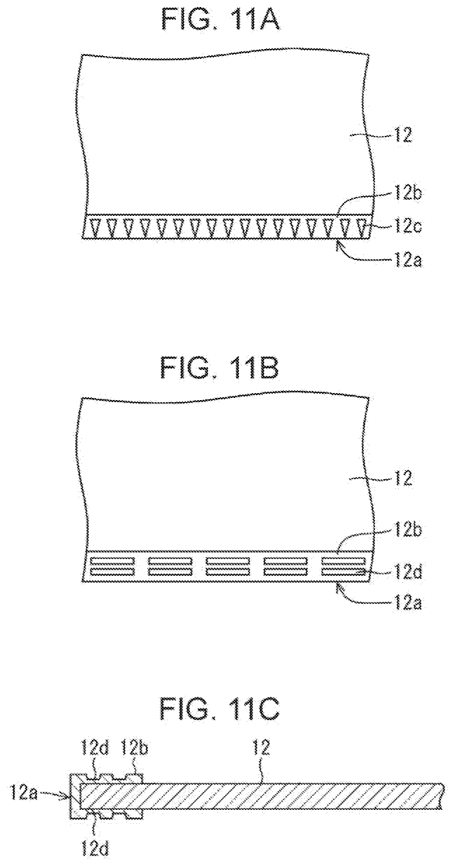

FIGS. 11A to 11C each illustrate an example of the above-mentioned pattern. Although the middle shelf plate 12 is illustrated by way of example, the same description below applies also to the upper shelf plate 11 and the lower shelf plate 13. FIG. 11A depicts an exemplary case in which a pattern 12c is painted on a frame 12b disposed near the edge 12a of the middle shelf plate 12. The pattern 12c is similarly provided also on the underside of the frame 12b.

FIGS. 11B and 11C each depict a pattern obtained by providing grooves 12d in the frame 12b disposed near the edge 12a of the middle shelf plate 12, and applying color to the interior of each groove 12a. Applying color to the interior of each groove 12d ensures that the coloring is not visible when seen from the front of the refrigerator but visible when seen from above or below. This allows the user to readily recognize the edge 12a of the middle shelf plate 12 within the captured image acquired from the upper camera 61 or the lower camera 63, while minimizing the influence of such a pattern on design when the inside of the refrigerating compartment 10 is observed by the user.

### Exemplary Software Implementations

The control block (in particular, the controller 70) of each of the refrigerators according to the above-mentioned embodiments may be implemented by a logic circuit (hardware) formed in, for example, an integrated circuit (IC chip), or may be implemented by software.

In the latter case, the refrigerator includes a computer that executes instructions given from, a program representing software for implementing various functions. The computer includes, for example, at least one processor (controller), and at least one computer-readable recording medium storing the above-mentioned program. As the processor of the computer reads the program from the recording medium and executes the read program, characteristic features of the present disclosure are achieved. As the processor, for example, a central processing unit (CPU) may be used. As the recording medium, a “non-transitory physical medium” may be used, examples of which include, in addition to a read only memory (ROM), media such as a tape, a disc, a card, a semiconductor memory, or a programmable logic circuit. The computer may further include, for example, a random access memory (RAM) to which the program is loaded. The program may be supplied to the computer via any given transmission medium (such as a communication network or broadcast waves) capable of transmitting the program. In one aspect of the present disclosure, the program may be implemented in the form of a data signal embedded in a carrier wave and embodied in an electronic transmission.

### CONCLUSION

A refrigerator according to a first aspect of the present disclosure includes a refrigerating compartment having a plurality of shelf levels each separated by a shelf plate, a door for the refrigerating compartment, and a camera disposed on the door such that the camera faces each shelf level. The camera includes a plurality of cameras each provided for corresponding one of the shelf levels and arranged in a vertical plane parallel to the door. Each camera has an angle of view that covers the door-side edge of a shelf plate disposed between a shelf level that the camera faces and an adjacent shelf level, the adjacent shelf level being positioned in an upwardly or downwardly adjacent relation to the shelf level.

The above-mentioned configuration makes it possible for the user to identify a stored item even if the stored item is placed near the door-side edge of a shelf plate.

Examples of cases where the refrigerating compartment has a plurality of shelf levels include when the refrigerating compartment 10 illustrated in FIG. 1 has the upper shelf level R1 and the middle shelf level R2.

A refrigerator according to a second aspect of the present disclosure is configured such that, in the first aspect, the angle of view may further cover the door-side edge of a shelf plate disposed between the shelf level that the camera faces and a shelf level adjacent to a side of the shelf level opposite to where the adjacent shelf level is positioned.

The above-mentioned configuration makes it possible for the user to more easily identify a stored item even if the stored item is placed near the door-side edge of a shelf plate.

A refrigerator according to a third aspect of the present disclosure is configured such that, in the first or second aspect, the refrigerator may further include a determiner that, based on an image captured by the camera, determines the state in which a stored item is placed in each shelf level, and a notifier that notifies a user if it is determined by the determiner that the stored item is not placed properly. The determiner may determine based on the image captured by the camera, whether the stored item is in proximity to the camera. The notifier may notify the user if the stored item is determined to be in proximity to the camera.

With the above-mentioned configuration, whether a stored item is placed inappropriately can be determined in a simple manner, and if the stored item is placed inappropriately, the user is urged to improve how the item is placed. This helps reduce the occurrence of situations where it is difficult to observe a stored item by means of a camera, and also reduce imbalances in cooling from occurring between various areas in the refrigerating compartment.

A refrigerator according to a fourth aspect of the present disclosure is configured such that, in the first or second aspect, the refrigerator may further include a determiner that, based on an image captured by the camera, determines the state in which a stored item is placed in each shelf level, and a notifier that notifies a user if it is determined by the determiner that the stored item is not placed properly. The determiner may determine, based on an image captured by a camera disposed facing a shelf level adjacent to the shelf level, whether the stored item is placed within a predetermined area near the door-side edge of the shelf plate. The notifier may notify the user if the stored item is determined to be placed within the predetermined area near the door-side edge of the shell-plate.

With the above-mentioned configuration, whether a stored item is placed inappropriately can be determined in a simple manner, and if the stored item is stored inappropriately, the user is urged to improve how the item is stored. This helps reduce the occurrence of situations where it is difficult to observe a stored item by means of a camera, and also reduce imbalances in cooling from occurring between various areas in the refrigerating compartment.

A refrigerator according to a fifth aspect of the present disclosure is configured such that, in the first to fourth aspects, the refrigerator may further include a display that displays an image of each shelf level, the image including an image captured by the camera facing the shelf level, and an image captured by a camera facing a shelf level adjacent to the shelf level.

With the above-mentioned configuration, the state in which an item is stored in each shelf level can be presented to the user in an easily recognizable manner.

A refrigerator according to a sixth aspect of the present disclosure is configured such that, in the first to fifth aspects, the plurality of cameras may be disposed in a vertical line.

The above-mentioned configuration helps provide maximum storage space on the inside of the door where the cameras are installed.

A refrigerator according to a seventh aspect of the present disclosure is configured such that, in the first to sixth aspects, the stored item may be visible through the shelf plate.

With the above-mentioned configuration, an item stored inside a shelf level can be identified through the shelf plate from a camera located above or below.

A refrigerator according to an eighth aspect of the present disclosure is configured such that, in the first to seventh aspects, a pattern may be provided in an area in the vicinity of the door-side edge of the shelf plate.

With the above-mentioned configuration, the door-side edge of a shelf plate can be easy recognized when a shelf level is observed from a camera located above or below, thus making it possible to easily determine the state in which an item is stored inside the shelf level.

The present disclosure is not limited to the embodiments mentioned above but various modifications or alterations are possible within the scope of the appended claims. Embodiments obtained by suitably combining technical measures disclosed in different embodiments also fall within the technical scope of the present disclosure. Further, technical measures disclosed in individual embodiments may be combined to provide new technical features.

The present disclosure contains subject matter related to that disclosed in Japanese Priority Patent Application JP 2018-140288 filed in the Japan Patent Office on Jul. 26, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A refrigerator comprising:
a refrigerating compartment having a plurality of shelf levels each separated by a shelf plate;
a door for the refrigerating compartment; and
a camera disposed on the door such that the camera faces each shelf level,
wherein the camera comprises a plurality of cameras each provided for corresponding one of the shelf levels and arranged in a vertical plane parallel to the door, and each camera has an angle of view that covers a door-side edge of a shelf plate disposed between a shelf level that the camera faces and an adjacent shelf level, the adjacent shelf level being positioned in an upwardly or downwardly adjacent relation to the shelf level.

2. The refrigerator according to claim 1,
wherein the angle of view further covers a door-side edge of a shelf plate disposed between the shelf level that the camera faces and a shelf level adjacent to a side of the shelf level opposite to where the adjacent shelf level is positioned.

3. The refrigerator according to claim 1, further comprising:
a determiner that, based on an image captured by the camera, determines a state in which a stored item is placed in each shelf level; and
a notifier that notifies a user if it is determined by the determiner that the stored item is not placed properly,
wherein the determiner determines, based on the image captured by the camera, whether the stored item is in proximity to the camera, and
wherein the notifier notifies the user if the stored item is determined to be in proximity to the camera.

4. The refrigerator according to claim 1, further comprising:
a determiner that, based on an image captured by the camera, determines a state in which a stored item is placed in each shelf level; and
a notifier that notifies a user if it is determined by the determiner that the stored item is not placed properly,
wherein the determiner determines, based on an image captured by a camera disposed facing a shelf level adjacent to the shelf level, whether the stored item is placed within a predetermined area near the door-side edge of the shelf plate, and
wherein the notifier notifies the user if the stored item is determined to be placed within the predetermined area near the door-side edge of the shelf plate.

5. The refrigerator according to claim 1, further comprising:
a display that displays an image of each shelf level, the image including an image captured by the camera facing the shelf level, and an image captured by a camera facing a shelf level adjacent to the shelf level.

6. The refrigerator according to claim 1,
wherein the plurality of cameras are disposed in a vertical line.

7. The refrigerator according to claim 1,
wherein the stored item is visible through the shelf plate.

8. The refrigerator according to claim 1,
wherein a pattern is provided in an area in a vicinity of the door-side edge of the shelf plate.
